(19) United States
(12) Patent Application Publication
(10) Pub. No.: US 2015/0219322 A1
(43) Pub. Date: Aug. 6, 2015

(54) LIGHT EMITTING DIODE LAMP TUBE

(71) Applicant: YAFERTECH CORP., GUANGDONG (CN)

(72) Inventor: Cheng-Wen Lin, New Taipei City (TW)

(21) Appl. No.: 14/420,772

(22) PCT Filed: Apr. 8, 2013
(86) PCT No.: PCT/CN2013/073861

§ 371 Date: Feb. 10, 2015

(30) Foreign Application Priority Data
Jan. 29, 2013 (CN) 201320048559.2

(51) Int. Cl. F21V 19/00; F21V 23/06

(52) U.S. Cl. CPC F21V 19/0075; F21V 19/003; F21V 23/06; F21Y 2103/003

(57) ABSTRACT

A light emitting diode lamp tube includes a tubular body, a light source module and two latch cover. The tubular body includes two openings formed on two opposite ends of the tubular body respectively and two first joining portions disposed near the openings respectively. The light source module is inserted into the tubular body and includes a control circuit board, at least one terminal member and a plurality of light emitting diodes, wherein the light emitting diodes are coupled to the control circuit board, and the terminal member is coupled to one end of the control circuit board. The latch covers covering the opposite ends respectively, wherein each of the latch covers comprises a second joining portion joined to the first joining portion, at least one second positioning portion joined to the first positioning portion and two conductive pins electrically connected to the terminal member.

### FIELD OF THE INVENTION

The present invention relates to a light emitting diode lamp tube, and in particular to a modular type light emitting diode lamp tube.

### BACKGROUND OF THE INVENTION

Typical light emitting diode lamp tubes are often assembled by bolts, adhesive or high frequency heating, but such assembling processes cannot be conducted into automatic production line effectively and often cause failure to damage manufacture equipment, or cause damage of light emitting diode lamp tubes themselves. This is one of the reasons for high manufacturing cost. The typical light emitting diode lamp tube has many parts for assembly, and the assembly process is so complicated that more labor and time are needed to raise yield rate and capacity, which causes high manufacturing cost and is disadvantageous for enterprise development. It is desired to improve the typical light emitting diode lamp tubes through simplification of their structure so as to reduce their manufacturing cost and increase their yield rate and capacity.

### SUMMARY OF THE INVENTION

An object of the present invention is to provide a light emitting diode lamp tube to improve the drawbacks of the conventional light emitting diode lamp tube.

According to an embodiment of the present invention, a light emitting diode lamp tube includes a tubular body, a light source module and two latch covers. The tubular body further includes two opposite ends, two opposite inner sides, two openings formed on the opposite ends respectively, two first joining portions disposed near the openings respectively, two control circuit board grooves formed on the opposite inner sides respectively and at least two first positioning portions disposed on an inner wall of the control circuit board grooves respectively. The light source module is inserted into the tubular body and includes a control circuit board, at least one terminal member and a plurality of light emitting diodes, wherein the light emitting diodes are coupled to the control circuit board, and the terminal member is coupled to one end of the control circuit board. The latch covers cover the opposite ends of the tubular body respectively, wherein each of the latch cover includes a second joining portion joined to the first joining portion, at least one second positioning portion joined to the first positioning portion and two conductive pins electrically connected to the terminal member.

In an embodiment of the present invention, the first joining portion has a hole, and the second joining portion is a latch.

The present invention provides a modular type LED lamp tube with simplified structure, whereby the manufacturing cost is reduced, the manufacturing process is simplified, and the yield rate and capacity is increased.

### BRIEF DESCRIPTION OF THE DRAWINGS

The present invention will be apparent to those skilled in the art by reading the following description of preferred embodiments thereof with reference to the drawings, in which:

FIG. 1 is a perspective view of an embodiment of a light emitting diode lamp tube of the present invention;

FIG. 2 is an exploded view of an embodiment of a light emitting diode lamp tube of the present invention; and

FIG. 3 is a cross-sectional view of an embodiment of a light emitting diode lamp tube of the present invention.

### DETAILED DESCRIPTION OF THE PREFERRED EMBODIMENTS

A light emitting diode lamp tube includes a tubular body, a light source module and two latch cover. The tubular body includes two openings formed on two opposite ends of the tubular body respectively and two first joining portions disposed near the openings respectively. The light source module is inserted into the tubular body and includes a control circuit board, at least one terminal member and a plurality of light emitting diodes, wherein the light emitting diodes are coupled to the control circuit board, and the terminal member is coupled to one end of the control circuit board. The latch covers cover the opposite ends respectively, wherein each of the latch cover includes a second joining portion joined to the first joining portion, at least one second positioning portion joined to the first positioning portion and two conductive pins electrically connected to the terminal member. The present invention provides a modular type LED lamp tube with simplified structure, whereby the manufacturing cost is reduced, the manufacturing process is simplified, and the yield rate and capacity is increased.

The following description is of the best-contemplated mode of carrying out the invention. This description is made for the purpose of illustrating the general principles of the invention and should not be taken in a limiting sense. The scope of the invention is best determined by reference to the appended claims.

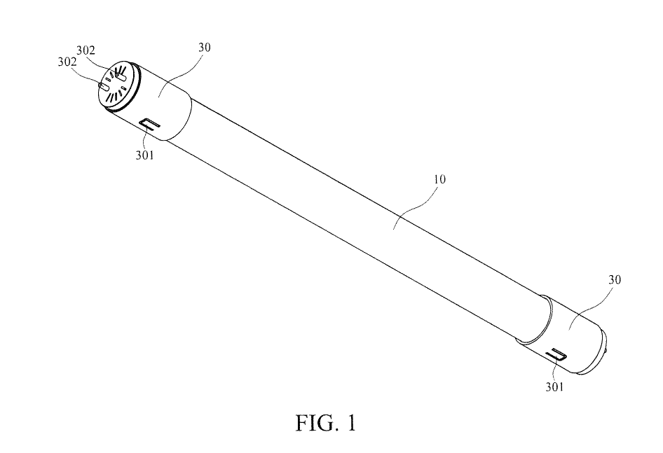

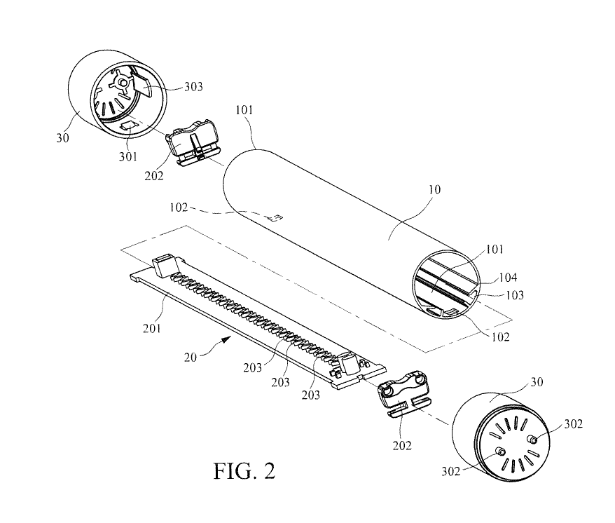

Referring to FIGS. 1-3, a light emitting diode lamp tube includes a tubular body 10, a light source module 20 and two latch covers 30. The tubular body 10 includes two opposite ends, and each of the ends has an opening 101 and a first joining portion 102 disposed near the opening 101. In this embodiment, the first joining portion 102 is a hole. Two control circuit board grooves 103 are formed on two opposite inner sides of the tubular body 10 respectively. At least one first positioning portion 104 is disposed within the tubular body 10. A light source module 20 is inserted into the tubular body 10. The light source 20 includes a control circuit board 201, at least one terminal member 202 and a plurality of light emitting diodes 203. The light emitting diodes 203 are coupled to the control circuit board 201, and the terminal member 202 is coupled to one side of the control circuit board 201. The latch covers 30 covering the ends of the tubular body 10 respectively. Each of the latch covers 30 has a second joining portion 301 joined to the first joining portion 102. In this embodiment, the second joining portion 301 is a latch. Each latch cover 30 includes two conductive pins 302 electrically connected to the terminal member 202. Each latch cover 30 further includes a second positioning portion 303 joined to the first positioning portion 104.

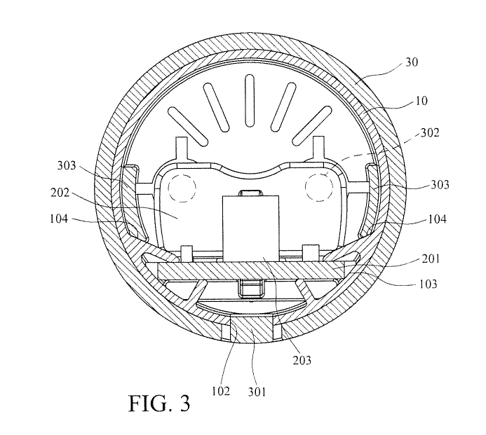

Referring to FIGS. 1-3, when the light emitting diode lamp tube is assembled, the light emitting diodes 203 are coupled to the control circuit board 201, and afterwards the control circuit board 201 is inserted into the control circuit board grooves 103 of the tubular body 10. The terminal members 202 are coupled to two sides of the control circuit board 201. Finally, the latch covers 30 engage the two ends of the tubular body 10 through engagement of the second joining portions 301 with the first joining portion 102. The second positioning portions 303 are connected to the first positioning portions 104 for stable positioning as shown in FIG. 3, and the conductive pins 302 are coupled to the terminal member 202. Therefore, the light emitting diode lamp of the present invention ca be quickly assembled without bolts, adhesive, high frequency heating or welding.

Although the present invention has been described with reference to the preferred embodiments thereof, it is apparent to those skilled in the art that a variety of modifications and changes may be made without departing from the scope of the present invention which is intended to be defined by the appended claims.

1. A light emitting diode lamp tube, comprising:
a tubular body comprising two opposite ends, two opposite inner sides, two openings formed on the opposite ends respectively, two first joining portions disposed near the openings respectively, two control circuit board grooves formed on the opposite inner sides respectively and at least two first positioning portions disposed on an inner wall of the control circuit board grooves respectively;
a light source module inserted into the tubular body and comprising a control circuit board, at least one terminal member and a plurality of light emitting diodes, wherein the light emitting diodes are coupled to the control circuit board, and the terminal member is coupled to one end of the control circuit board; and
two latch covers covering the opposite ends respectively, wherein each of the latch covers comprises a second joining portion joined to the first joining portion, at least one second positioning portion joined to the first positioning portion and two conductive pins electrically connected to the terminal member.

2. (canceled)

3. The light emitting diode lamp tube as claimed in claim 1, wherein the first joining portion is a hole, and the second joining portion is a latch.

4. (canceled)
